(19) United States
(12) Patent Application Publication
(10) Pub. No.: US 2026/0228540 A1
(43) Pub. Date: Aug. 6, 2026

(54) MACHINE LEARNING MODELS WITH PARALLEL ADAPTERS

(71) Applicant: QUALCOMM Incorporated, San Diego, CA (US)

(72) Inventors: Debasmit DAS, San Diego, CA (US); Ankita NAYAK, Milpitas, CA (US); Edward TEAGUE, San Diego, CA (US); Munawar HAYAT, San Diego, CA (US); Fatih Murat PORIKLI, San Diego, CA (US)

(21) Appl. No.: 19/044,477

(22) Filed: Feb. 3, 2025

(51) Int. Cl. G06N 3/09; G06N 3/045

(52) U.S. Cl. CPC G06N 3/09; G06N 3/045

(57) ABSTRACT

Systems and techniques are described herein for configuring machine learning models with parallel low rank adapters. For example, an apparatus comprising one or more processors and configured to: obtain a plurality of embeddings associated with input content; determine a plurality of probability values corresponding to a plurality of clusters, wherein each probability value corresponds to a probability a respective embedding belongs to a particular cluster; generate a plurality of output values based on input tokens associated with the input content, the plurality of output values including a first output value associated with the first model, a second output value associated with a first adapter of the first model, and a third output value associated with a second adapter of the first model; combine the plurality of output values based on the plurality of probability values into a combined value; and output content generated based on the combined value.

### TECHNICAL FIELD

The disclosure relates generally to machine learning models. For example, aspects of the present disclosure include systems and techniques for configuring machine learning models with parallel adapters.

### BACKGROUND

A multimodal generative machine learning (ML) system generates natural language responses from natural language inputs and can incorporate various forms of data, such as audio, images and text. For instance, such an ML system can include an encoder that processes audio features (such as spectral, temporal, and pitch features). A generative ML system can use features to generate relevant responses in natural language form. The generative ML system can also generate other modes of output, such as an image and audio, as well as an explanation of that content.

A generative ML system can perform a wide range of tasks such as answering questions, providing explanations, generating creative content, assisting with coding, and offering recommendations. Various tools may be connected to the generative ML system to allow interaction with external systems, such as browsing the Internet, generating images, executing code, etc. Generative ML systems are designed to assist users in solving problems, learning new information, and enhancing productivity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for configuring machine learning models with parallel adapters. In some aspects, an apparatus for generating content is provided. The apparatus includes at least one memory (e.g., configured to store data) and at least one processor (e.g., implemented in circuitry) coupled to the at least one memory and configured to: obtain a plurality of embeddings associated with input content; determine, for the plurality of embeddings, a plurality of probability values corresponding to a plurality of clusters, wherein each probability value corresponds to a probability a respective embedding belongs to a particular cluster of the plurality of clusters; generate, using a first model of a machine learning model, a plurality of output values based on input tokens associated with the input content, the plurality of output values including a first output value associated with the first model, a second output value associated with a first adapter of the first model, and a third output value associated with a second adapter of the first model; combine the plurality of output values based on the plurality of probability values into a combined value; and output content generated based on the combined value.

In some aspects, a method is provided for generating content. The method includes: obtaining a plurality of embeddings associated with input content; determining, for the plurality of embeddings, a plurality of probability values corresponding to a plurality of clusters, wherein each probability value corresponds to a probability a respective embedding belongs to a particular cluster of the plurality of clusters; generating, by a first model of a machine learning model, a plurality of output values based on input tokens associated with the input content, the plurality of output values including a first output value associated with the first model, a second output value associated with a first adapter of the first model, and a third output value associated with a second adapter of the first model; combining the plurality of output values based on the plurality of probability values into a combined value; and outputting, by the machine learning model, content generated based on the combined value.

In some aspects, a non-transitory computer-readable medium is provided having stored thereon instructions that, when executed by at least one processor, cause the at least one processor to: obtain a plurality of embeddings associated with input content; determine, for the plurality of embeddings, a plurality of probability values corresponding to a plurality of clusters, wherein each probability value corresponds to a probability a respective embedding belongs to a particular cluster of the plurality of clusters; generate, using a first model of a machine learning model, a plurality of output values based on input tokens associated with the input content, the plurality of output values including a first output value associated with the first model, a second output value associated with a first adapter of the first model, and a third output value associated with a second adapter of the first model; combine the plurality of output values based on the plurality of probability values into a combined value; and output content generated based on the combined value.

In some aspects, an apparatus for generating content is provided. The apparatus includes: means for obtaining a plurality of embeddings associated with input content; means for determining, for the plurality of embeddings, a plurality of probability values corresponding to a plurality of clusters, wherein each probability value corresponds to a probability a respective embedding belongs to a particular cluster of the plurality of clusters; means for generating, by a first model of a machine learning model, a plurality of output values based on input tokens associated with the input content, the plurality of output values including a first output value associated with the first model, a second output value associated with a first adapter of the first model, and a third output value associated with a second adapter of the first model; means for combining the plurality of output values based on the plurality of probability values into a combined value; and means for outputting, by the machine learning model, content generated based on the combined value.

In some aspects, a method of training a machine learning model is provided. The method includes method of training a machine learning model, comprising: obtaining a plurality of clusters associated with a dataset, the plurality of clusters including at least a first cluster and a second cluster; tuning a first adapter connected to a first machine learning model based on the dataset and the plurality of clusters; tuning a second adapter connected to the first machine learning model based on the dataset and the plurality of clusters; and obtaining a second machine learning model based on combining the first adapter and the second adapter with the first machine learning model.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile devices), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating a multimodal generative machine learning system for generating natural language responses based on natural language input from a prompt and any additional information;

FIG. 2 is a conceptual block diagram of a generative response engine 200 that is configured for multimodal input and output in accordance with some aspects of the disclosure;

FIG. 3 is a conceptual block diagram of a generative machine learning model including parallel adapters in accordance with some aspects of the disclosure;

FIG. 4 is an example graph illustrating different clusters based on two different features in accordance with some aspects of the disclosure;

FIG. 5 is a conceptual block diagram of a training system that is configured to train a generative machine learning model including parallel adapters in accordance with some aspects of the disclosure;

FIG. 6 is a flow diagram illustrating an example of a process for training a machine learning model with parallel adapters in accordance with some aspects of the disclosure;

FIG. 7 is a flow diagram illustrating an example process of a machine learning model with parallel adapters for generating a response to a natural language response in accordance with some aspects of the disclosure;

FIG. 8 is a block diagram of an example transformer in accordance with some aspects of the disclosure; and

FIG. 9 shows an example of a computing system, which may be for example any computing device that may implement components of the system.

### DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Generative machine learning (ML) models can provide a conversational interface that uses natural language prompts as inputs, such as text or voice. For instance, a user can provide an input prompt in natural language to the generative ML model, and the generative ML model can provide a response in natural language form. The input prompt and the output response can optionally be combined with one or more other types of information or data, such as images or files. For example, the generative ML model can be requested to perform a particular function with an input image or write code based on structured data (e.g., extensible markup language (XML) or JavaScript object notations (JSON), etc.) within the file.

ML models, such as generative ML models, can be fine-tuned to improve performance in specific tasks. Fine-tuning can involve adapting a pre-trained ML model (e.g., a pre-trained generative ML model or other type of ML model) to a specific task by updating parameters (e.g., weights and/or other parameters) of the ML model using task-specific training data. The fine-tuning process allows the ML model to leverage its pre-existing knowledge while specializing in new tasks. Fine-tuning typically requires less data and computing than fully training a previously untrained ML model. Fine-tuning can thus be useful for improving performance of ML models on domain-specific tasks without sacrificing the benefits of large-scale pretraining.

One technique for fine tuning ML models is to use an adapter, such such as a Low-Rank Adapter (LoRA). An adapter is a lightweight trainable model that connects to different layers (or blocks) of an ML model (e.g., a first adapter connected to a first layer, a second adapter connected to a second layer, etc.). Adapters can be used to efficiently adapt large pre-trained models to specific tasks with minimal computational cost and resource usage. Adapters (e.g., a LoRA) can be trained to generalize task-specific information to a frozen (e.g., immutable) pre-trained machine learning model. For instance, LoRA introduces lightweight trainable modules parameterized as low-rank matrices into an original (e.g., pre-trained) ML model to capture task-specific information while the original ML model parameters remain frozen, preserving the pre-trained knowledge of the ML model. Training a LoRA can include injecting low-rank layers into certain layers of the base model (e.g., attention layers in a transformer model, feedforward layers in the transformer model, convolutional layers in a transformer and/or convolutional model, etc.) to optimize the layers during training and reduce the number of overall parameters that need to be updated. Such a technique can be performed to overcome the computational challenges of fine-tuning large machine learning models, such as when working with a smaller dataset.

The generalization of a single adapter (e.g., a single LoRA) can be an issue when there are distinct tasks that require conflicting or highly specialized representations. For example, LoRA may focus on maintaining a balance between preserving capabilities of the base model and learning new information. LoRA may thus struggle to learn tasks that deviate significantly from the pre-trained model. The low rank structure of a LoRA may inherently restricts the capacity of the LoRA to include complex or divergent features from the base model. For instance, when there are two similar tasks that have different outputs, the LoRA may not sufficiently be able to identify the correct task.

Systems, apparatuses, processes (also referred to as methods), and computer-readable media (collectively referred to as “systems and techniques”) are described herein for configuring machine learning models with parallel adapters (e.g., parallel LoRAs or other types of adapters). For example, an apparatus is configured to obtain embeddings associated with input content (e.g., an input prompt into a machine learning model) and determine probability values corresponding to a plurality of clusters based on the embeddings. The machine learning model includes an adapter for each cluster and enables specialized learning to be applied by that adapter.

In some aspects, a machine learning model with parallel adapters is trained based on a training dataset that is clustered at design time to handle different domains of tasks or knowledge. Clustering is the process of grouping data points into clusters such that points within the same cluster are more similar to each other than to those in different clusters. Clustering is a supervised or unsupervised technique that identifies hidden patterns or natural groupings in the training data. For example, a machine learning model for customer service may include clusters for different types of products offered and different types of services available for an end user.

In some aspects, each adapter of the machine learning model may be independent training using the training data. For example, in the case of two clusters and two adapters, in a first cluster epoch, the machine learning model is configured with only the first adapter, and, during the second cluster epoch, the machine learning model is configured with only the second adapter. During each cluster epoch, training data (including data for the first cluster and the second cluster) is provided to the training system (e.g., using frameworks such as PyTorch, SciKit, Tensorflow, etc.) and the machine learning model and the corresponding adapter learn how to perform tasks and generate responses based on verification data. In some cases, training data that is not associated with the current cluster is negatively weighted to assist the adapter in penalizing the learning process to learn away from this cluster.

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

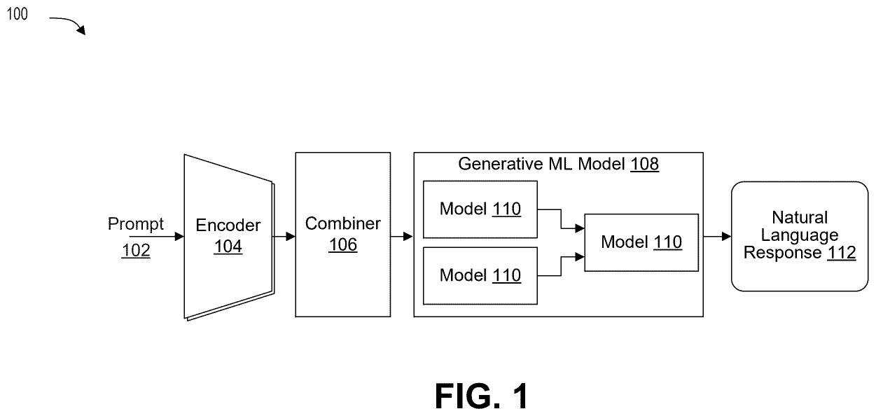

FIG. 1 is a block diagram illustrating a multimodal generative ML system 100 for generating natural language responses based on natural language input from a prompt 102 and any additional information. A multimodal machine learning system is an ML model that receives, processes, and outputs data in multiple forms. For example, the input prompt may include text, images, and audio.

For example, the multimodal generative ML system 100 includes a plurality of encoders 104 that are each configured to encode different modes of content (e.g., text, images, audio, etc.) into different tokens within a common embedding space. For example, the text may be segmented based on different techniques (e.g., paragraph, sentence, etc.) and encoded by an encoder 104 into tokens. In another example, images can be provided to an encoder 104 that extracts features associated with the image and generates tokens representing the visual features. In another example, audio can be provided to an encoder that extracts features associated with the image and generates tokens representing the audio features. In the case of audio, the encoder 104 may identify features that might include formants that characterize resonant frequencies in speech, rhythmic features related to timing and tempo, and harmonic features that describe the relationship between fundamental frequencies and their harmonics.

The different tokens from the plurality of encoders are provided to combiner 106 that combines the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint 8 array), and another string. The byte array may be audio, images, or other content that can be processed by the encoder 104 (e.g., a PDF, etc.). In some aspects, the combiner 106 is configured to concatenate the different tokens in order based on the array to preserve the semantic order of features and provide the tokens to the generative ML model 108.

The generative ML model 108 is configured to receive the response and generate a natural language response 112 based on the input information. The generative ML model 108 is configured to use the features extracted from the encoder 104 and extract different types of features from the text that are relevant. For example, the text can be a query for a particular type of information. The generative ML model 108 extracts different tasks that are related to the query and then performs those tasks, such as writing code to perform a particular function, generating an image based on an input image with expressed modifications, generate an image without any input image, and so forth.

The generative ML model 108 may include different components, such as a featurization engine to identify different types of features, identify inferences within the text (e.g., pronoun usage and corresponding disambiguation functions), data retrieval engines (e.g., to identify features related to a particular concept observed by the generative ML model 108), and so forth. The generative ML model 108 may also include different types of models 110 and engines to synthesize a coherent contextual output that synthesizes the input content and information that is responsive to tasks embedded within the text. For example, the generative ML model 108 may include a predictive output engine (not shown) that is configured to generate a sequence of words that is the most likely contextually correct and provide a coherent and contextually relevant answer. For example, the predictive output generation engine generates responses by sampling from the probability distribution of possible words and sequences based on patterns observed during training. The generative ML model 108 may also include a predictive output generation engine to generate multiple responses that are potentially relevant and coherent. The generative ML model 108 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

The generative ML model 108 may include various types of ML models, such as a transformer. A transformer is a neural network architecture built into natural language processing (NLP) tasks, such as language translation, sentiment analysis, and text summarization. Conventional traditional recurrent neural networks (RNNs) process data in sequence, which slows the operations and training. A transformer or transformer network can process input in parallel and is faster and more efficient than sequential training and processing. In some aspects, transformers use a self-attention mechanism, which allows a transformer to identify the most relevant parts of the input text or content (e.g., audio or video). In some cases, transformers can also use a cross-attention mechanism which uses other content or data to determine the most relevant parts of the input. For example, cross-attention mechanisms are useful in sequential content such as a stream of data, such as optical flow, and other computer vision techniques.

A transformer model includes a multi-layer encoder-decoder architecture. The encoder takes the input text, converts the input text into a sequence of hidden representations, and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative ML model 108 may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

In one example, the generative ML model 108 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters and would result in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

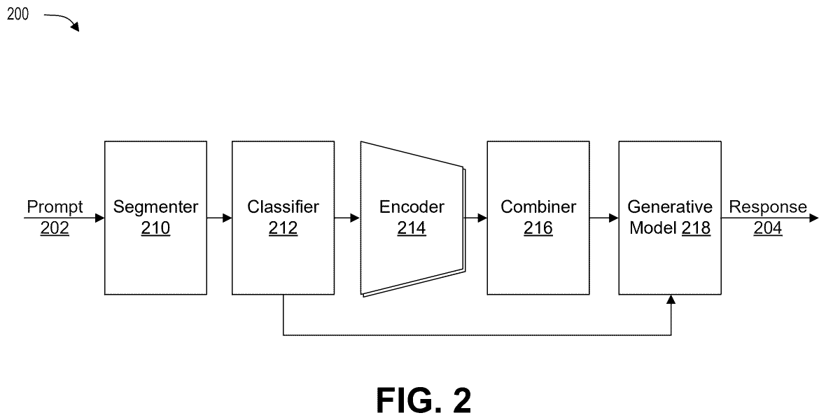

FIG. 2 is a conceptual block diagram of a generative response engine 200 that is configured for multimodal input and output in accordance with some aspects of the disclosure. In some aspects, the generative response engine 200 is configured to receive a prompt (e.g., from a user, an application programming interface (API) request, etc.) and perform various processing to generate a response 204 that is responsive to the prompt 202 that is contextually accurate. In some aspects, the generative response engine 200 includes a plurality of adapters (e.g., LoRA) that are trained in different intervals to improve a machine learning model's performance during inference. For example, a single adapter is generically trained based on a sample dataset to improve inference and task performance but can struggle when there the adapter cannot distinguish the task, and the model's pretrained weights override the adapter.

In some aspects, the generative response engine 200 includes a generative machine learning model 218 that includes a plurality of adapters that are trained to perform different tasks. In some aspects, each adapter is trained in a distinct interval based on clustered data corresponding to that task and independently configure each adapter for a specific task. In this manner, the independently trained adapters are configured to prevent the model from defaulting to the application of the base model's weights and allow the combination of the base model and the adapters to accurately provide specialized responses that correspond to the fine tuning.

The generative response engine 200 includes various components such as a segmenter 210, a classifier 212, a plurality of encoders 214, a combiner 216, and a generative machine learning model 218. In some aspects, the prompt 202 may be an array of primitive values, such as text, binary data (byte arrays, etc. For example, the prompt may be a union type that combines different types of primitive data (e.g., string|uint8array in JavaScript). The segmenter 210 is configured to segment different content into different portions based on various limitations, such as text size, image size, and so forth. In some cases, the segmenter 210 may also reduce the scope of content such as an image size based on limitations of a machine learning model. For example, machine learning models may be trained on a particular size input to extract important features. The segmenter 210 may also segment text into different chunks, such as into individual sentences or paragraphs.

In some aspects, the classifier 212 may be configured to classify the input based on a plurality of clusters. For example, the classifier 212 may be configured to generate embeddings that represent the features associated with the input (e.g., segmented text, images, etc.) in vector space. An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects.

The plurality of clusters may represent different semantic spaces for the operation of the generative response engine 200. The plurality of clusters may be related to different specialized tasks, data, or other operations and represent different domains of the generative response engine 200. For example, a generative model trained for customer service may need to learn different domains of knowledge, such as identification of products or services, accounting and billing information, a corpus of documents to help diagnose problems or provide information, and so forth. The plurality of clusters is a design time consideration based on the input and output from the generative response engine 200. In some aspects, the classifications are provided to the generative machine learning model 218 to activate specific learned domains.

The segmented portions of the prompt 202 are then provided into a plurality of encoders 214 (e.g., the encoders 104 in FIG. 1) to extract various features and generate tokens associated with those features. An embedding is a numerical representation of data, such as words, images, or items, in a continuous vector space that captures meaningful patterns, relationships, and similarities for computational processing. In some aspects, each encoder 214 is configured for a different modality or different type of input. For example, the generative response engine 200 may include an encoder 214 for encoding text, an encoder 214 for encoding images, and an encoder 214 for encoding audio. There may be additional encoders based on the different modalities. For example, there may be an encoder 214 for handling different types of documents (e.g., PDF, etc.).

The classifier 212 may generate a probability that the prompt 202 for each cluster, and each probability represents a likelihood that the prompt 202 is associated with the features in that corresponding cluster. In some aspects, the classifier 212 provides the probabilities associated with each cluster and the embeddings to the generative machine learning model 218.

The combiner 216 (e.g., the combiner 106 in FIG. 1) receives the tokens from the encoders 214 and synthesizes tokens that represent the prompt 202. For example, the combiner 216 is configured to concatenate the tokens from the encoders 214 in the correct order to preserve the semantic context of the content. For example, the encoders 214 may be configured to execute the encoding operations in parallel and because different content may be encoded at different rates, the tokens may be received out of order. The combiner 216 may receive information, either from the segmenter 210 or from the encoders 214 to identify how to sequence the embeddings into an input suitable for the generative machine learning model 218 (e.g., an array of tokens).

In some aspects, the generative machine learning model 218 is configured to use the embeddings during inference to begin inference operation based on the prompt 202. In some aspects, the probabilities are by the generative machine learning model 218 to activate at least one adapter based on the probability associated with that adapter. In some aspects, because the adapters are tuned independently based on clustered data, the adapters provide a stronger response based on the identification of features that more accurately represent that different classification.

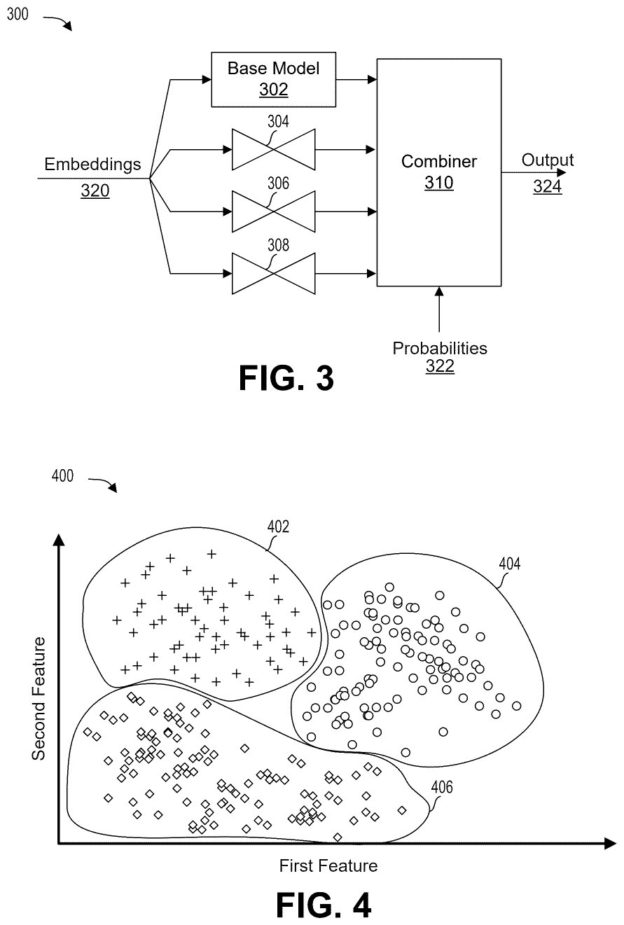

The generative machine learning model 218 is configured to synthesize the response 204 based on the probabilities provided by the classifier 212 and the generative machine learning model 218. Architecture and further aspects of the generative machine learning model 218 are further described in FIG. 3.

FIG. 3 is a conceptual block diagram of a generative ML model 300 (e.g., the generative machine learning model 218 in FIG. 2) that includes a plurality of adapters in accordance with some aspects of the disclosure. In some aspects, the generative ML model 300 includes a base model 302 that receives embeddings 320. The base model 302 is a trained model that contains knowledge derived from training on a large, diverse dataset. The base model 302 does not incorporate task-specific adaptations and may struggle to handle nuanced requirements, domain-specific terminology, or specialized contexts effectively. For example, a base model 302 would be unable to handle customer service automation functions of a business entity. A base model 302 is generic and provides a foundation for domain specific knowledge by refining weights or augmenting structure to prioritize task-relevant patterns and features using, for example, adapters. Non-limiting examples of a base model that can be further trained using various techniques include LLAMA, DeepSeek, generative pretrained transformer (GPT), and so forth.

The base model 302 receives the embeddings 320 (e.g., from the classifier 212 in FIG. 2) and is configured to generate output response tokens. The embeddings 320 are also provided to a plurality of adapters such as a first adapter 304, a second adapter 306, and a third adapter 308. Although FIG. 3 illustrates that the first adapter 304, a second adapter 306, and a third adapter 308 execute in parallel, the first adapter 304, a second adapter 306, and a third adapter 308 each are activated at particular layers of the base model 302 and generate output tokens.

In some aspects, each of the adapters 304, 306, and 308 are independently tuned based on a specific cluster of data from the plurality of clusters associated with the dataset. The number of adapters is equal to the number of clusters and is a design consideration based on the application of the/318 and generally corresponds to different domains of knowledge. For example, if the generative ML model 300 is configured for a customer service application of an automotive parts supplier, the generative ML model 300 may be configured for parts identification, billing assistance, order tracking, and support.

The base model 302, the first adapter 304, the second adapter 306, and the third adapter 308 output generated tokens to a combiner 310 based on the received embeddings 320. The combiner 310 also receives probabilities 322 (e.g., from the classifier 212) and is configured to generate an output 324. In some aspects, the output 324 may be in various forms, such as tokens that can be reassembled into a contextually accurate response. In other cases, the output 324 can be audio and/or text such as in the case of a customer service application

In some aspects, the generative ML model 300 includes a combiner 310 that is configured to receive the inference results from each of the base model 302, the first adapter 304, the second adapter 306, and the third adapter 308 and generate an output 324 and combine the inference results based on the probabilities 322 (e.g., from the classifier 212 in FIG. 2). In one aspect, the combiner 310 uses the probability to proportionally scale the inference results from the the first adapter 304, the second adapter 306, and the third adapter 308 and merge the scaled result with the result generated by the base model 302. For example, a weight wi may be calculated for each value from the adapters that is proportional to p(x, dᵢ) where x is embeddings from the input prompt and dᵢ is the probability that the input corresponds to cluster i. In some aspects, the probabilities may be omitted, and the weights can be proportionally scaled based on the number of values provided to the combiner 310 (e.g., scaled by 1/n).

In some aspects, different strategies can be employed by the combiner 310 to ensure that the output 324 is responsive to the received embeddings 320. For example, in the event that the combiner 310 also receive probabilities 322 are lower than a floor value or are within a threshold, the combiner 310 may use the output from the base model 302 since the values may indicate ambiguity between the different adapters.

FIG. 4 is an example graph 400 illustrating different clusters based on two different features in accordance with some aspects of the disclosure. Clusters are represented in many different dimensions (e.g., 768 dimensions) and the graph 400 is a simplified representation for illustration purposes that shows a first feature in the X plane and a second feature in the Y plane. A clustering model can identify clusters based on features not perceptible or observable to a person to generate the first cluster 402, the second cluster 404, and the third cluster 406. The clustering model is able to perceive non-linear boundaries in many different dimensions and generate a grouping mechanism that can identify whether input information corresponds to one of the first cluster 402, the second cluster 404, and the third cluster 406.

There are different types of clustering techniques that can be used to generate the clusters, such as partition-based clustering which divides data into non-overlapping subsets (e.g., K-means, which assigns points to the nearest cluster center), density-based clustering which groups points based on regions of high density and separates sparse regions as noise, hierarchical clustering which builds a tree-like structure of nested clusters using either a bottom-up (agglomerative) or top-down (divisive) approach, model-based clustering, fuzzy clustering, etc.

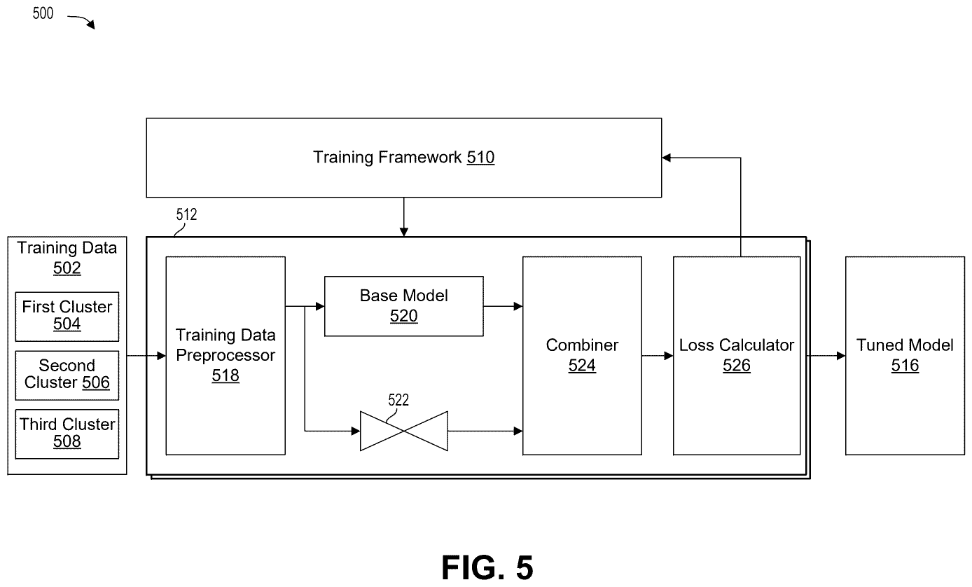

FIG. 5 is a conceptual block diagram of a training system 500 that is configured to train a generative machine learning model including parallel adapters in accordance with some aspects of the disclosure.

The training system 500 includes a training dataset 502 that is clustered into different clusters. In this example, the training dataset 502 is clustered into a first cluster 504, a second cluster 506, and a third cluster 508 that represent different domains of tasks and/or knowledge for the machine learning model. As detailed above, each cluster can be a design time consideration based on an explicit configuration (e.g., by a person) and the clustering engine can populate each item in the training dataset 502 into a corresponding cluster. In other aspects, an unsupervised or semi-supervised engine can generate the first cluster 504, the second cluster 506, and the third cluster 508 and then populate each item in the training dataset 502 into a corresponding cluster.

The training system 500 includes a training framework 510 that is configured to perform various functions such as executing a plurality of cluster epochs 512. Each cluster epoch 512 is configured to use the training dataset 502 to learn weights for a corresponding adapter 522 within a tuned model 516. For example, in the example of three clusters, the training system 500 may learn weights corresponding to the first cluster 504, weights for the second cluster 506, weights corresponding to the second cluster 506, and weights corresponding to the third cluster 508 that are embedded configured within the tuned model 516.

In some aspects, each cluster epoch 512 includes a training data preprocessor 518 that is configured to preprocess the training dataset 502 based on the cluster of the cluster epoch 512. For example, if the cluster epoch 512 is associated with the first cluster 504, the learn weights applies weights or other factors to assist facilitate learning patterns and other information of the first cluster 504. In some examples, the weights can make the training data of the other clusters (e.g., the second cluster 506 and the third cluster 508) negative samples to learn away from the patterns in these clusters. In other examples, the learn weights may omit the samples of the other clusters.

In some aspects, a base model 520 (e.g., the base model 302 in FIG. 3) and an adapter 522 may use each data sample from the training data preprocessor 518 to infer a response that is provided to a combiner 524 (e.g., the classifier 212, the combiner 310, etc.) to combine the responses. The combiner 524 provides the combined response to a loss calculator 526, which generates a loss associated with the combined response. The loss is provided to the training dataset 502 to perform a backpropagation to modify weights and learn how to handle the corresponding data. Each cluster epoch 512 may include a plurality of training epochs to allow the training framework 510 to tune the adapter 522 corresponding to that cluster epoch 512 (e.g., associated with the corresponding cluster data) within the tuned model 516.

When the loss determined by the loss calculator 526 is within a tolerance, the weights of the cluster epoch 512 are finalized and a cluster epoch 512 associated with the next cluster can begin (e.g., using the second cluster 506). The training framework 510 is configured to perform all the cluster epochs 512 and train the tuned model 516 to embed the adapters 522 in a parallel configuration. As described above, the tuned model 516 is configured to combine the responses from the base model 520 and the adapters 522 during inference. In some aspects, the loss calculator varies based on the modality of the content. In tokens corresponding to images, the loss calculator 526 is configured to use cross entropy. In the case tokens correspond to text, the loss calculator 526 is configured to use next token prediction.

In this manner, the tuned model 516 is configured to learn specialized domain knowledge that can distinguish between different clusters and learn multiple discrete tasks that are each specialized. Based on the learning techniques, the tuned model 516 does not generalize based on the specialized tasks, which improves the inference performance of the adapters and addresses issues with generalized training.

In some aspects, a tuned model 516 including the parallel adapters can be used for different implementations, such as photo stylization and recontextualization, language style adaptation, personalized multimodal models, multi-role chatbots, and so forth. For example, photo stylization and recontextualization may use multiple images of a person with an instruction to generate a new image of that person in a specific setting. In this example, the base model may be for example, a stable diffusion model and an adapter may be configured to learn the facial features of the person and an adapter is configured to learn the context associated with the modification, and the result is an image that captures important facial features of the person and generates a different image based on the context and the user's facial features. In an example of a tuned model 516 for language style adaptation, the different adapters can be configured for different modes of output, such as email generation, real-time chat content generation, and formal document generation.

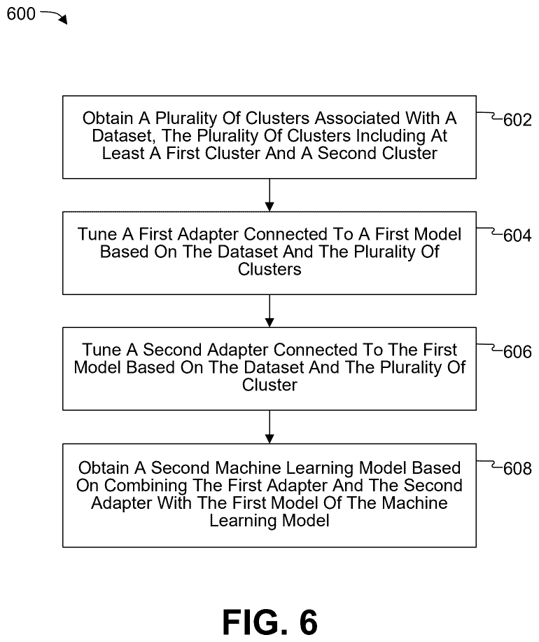

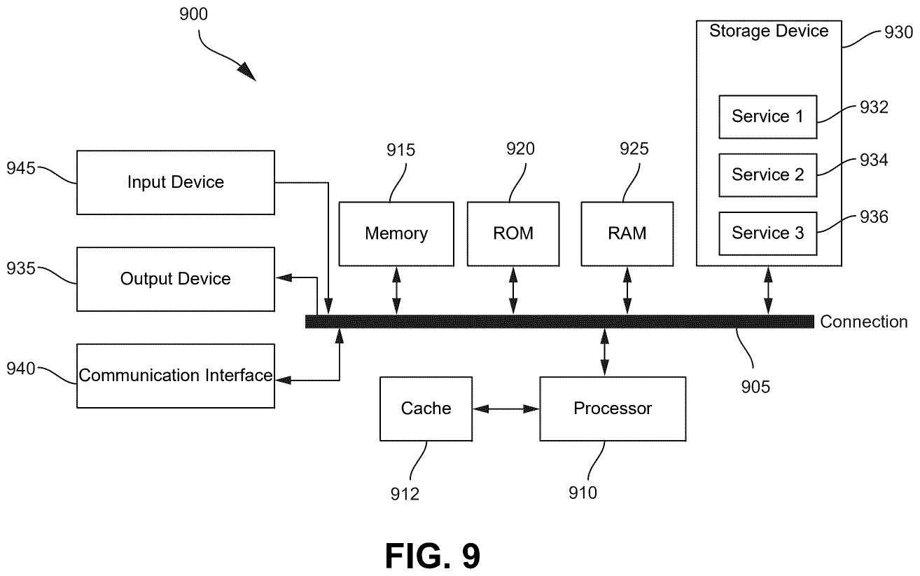

FIG. 6 is a flow diagram illustrating an example of a process for training a machine learning model with parallel adapters in accordance with some aspects of the disclosure. The process 600 (or any other described herein) can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 600 may be implemented as software components that are executed and run on one or more processors (e.g., CPU, GPU, DSP, NPU or neural engine, SoC, the processor 910 of FIG. 9, and/or other processor(s)).

In some aspects, at block 602, the computing system may obtain a plurality of clusters associated with a dataset, the plurality of clusters including at least a first cluster and a second cluster. For example, a cluster may be configured from a training dataset based on unsupervised or supervised techniques.

At block 604, the computing system may configure a first adapter connected to a first machine learning model based on the dataset and the plurality of clusters. For example, the computing system may execute a cluster epoch to train the first adapter with respect to data in the training set that corresponds to a first cluster in the plurality of clusters. As described above, data corresponding to a first cluster may be used as positive samples for the cluster epoch, and data from other clusters may be used as negative samples. In this way, the first adapter learns away from other clusters to prevent ambiguity. As described above, prevents potential ambiguity between the different adapters and improves the inference performance based on specialized training.

At block 606, the computing system may configure a second adapter connected to the first machine learning model based on the dataset and the plurality of clusters. For example, the computing system may execute a cluster epoch to train the second adapter with respect to data in the training set that corresponds to a second cluster in the plurality of clusters. As described above, data corresponding to a second cluster may be used as positive samples for the cluster epoch, and data from other clusters may be used as negative samples.

At block 608, the computing system may obtain a second machine learning model based on combining the first adapter and the second adapter with the first machine learning model. In some aspects, the computing system may configure a number of adapters corresponding to a number of clusters. The second machine learning model is configured to apply specialized training that is derived based on the generic training of the first machine learning model in addition to the training associated with each cluster.

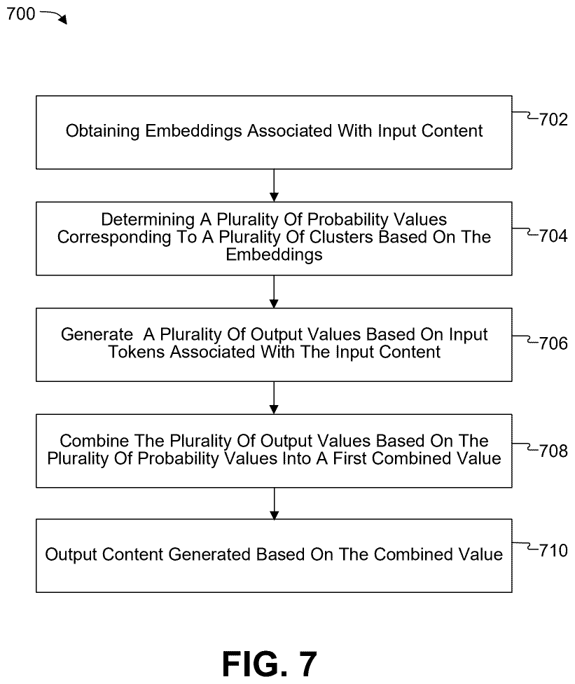

FIG. 7 is a flow diagram illustrating an example process 700 of a machine learning model with parallel adapters for generating a response to a natural language response in accordance with some aspects of the disclosure.

At block 702, the computing system may obtain embeddings associated with input content. For example, the machine learning model may include an embedding model that identifies features associated with the content.

In some aspects, the machine learning model is configured to receive and/or output multimodal content. For example, to handle multimodal input content, the computing system may generate first tokens associated with a first portion of the content based on a type of the first portion using a first encoder, generate second tokens associated with a second portion of the content based on a type of the second portion using a second encoder, and combine the first tokens and the second tokens into the input tokens. In one example, the first portion may be text and the second portion may be an image or audio.

At block 704, the computing system may determine a plurality of probability values corresponding to a plurality of clusters based on the embeddings. Each probability value of the embeddings corresponds to a probability to a single cluster in the plurality of clusters that the input content corresponds to that cluster. Other probabilities can also be used, such as normalized distances.

In one aspect, the computing system may determine a first distance from the embeddings to a first centroid associated with a first cluster corresponding to the first adapter, determine a second distance from the embeddings to a second centroid associated with a second cluster corresponding to the second adapter, and determine a first probability and a second probability based on the first distance and the second distance. In this way, a distance associated with the embeddings can be used to determine a normalized distance and a probability can be determined based on dividing the distances. For example, determining the distance may include normalizing the first distance and the second distance based on a normal value, and computing the probability based on the normalized first distance and the normalized second distance.

At block 706, the computing system may generate, by a first model of the machine learning model, a plurality of output values based on input tokens associated with the input content. The plurality of output values includes a first output value associated with the first model, a second output value associated with a first adapter of the first model, and a third output value associated with a second adapter of the first model.

At block 708, the computing system may combine the plurality of output values based on the plurality of probability values into a first combined value. The combining can occur based on a number of clusters or based on the probability of the clusters. For example, for fixed scaling based on the number of clusters, block 708 may include scaling the second output value based on a number of clusters in the plurality of clusters (e.g., divide by N, with N being the number of clusters), scaling the third output value based on the number of clusters in the plurality of clusters (divide by N), and summing the first output value, the scaled second output value, and the scaled third output value to generate the combined value.

In another example, for proportional scaling, block 708 may include scaling the second output value based on a first probability value from the plurality of probability values corresponding to the first adapter, scaling the third output value based on a second probability value from the plurality of probability values corresponding the second adapter; and summing the first output value, the scaled second output value, and the scaled third output value to generate the combined value.

In some aspects, the machine learning model may include a plurality of models. For example, the machine learning model may include additional models for text generation, image generation, text prediction, and so forth. Each of these models may include corresponding adapters and be in various configurations (e.g., series, parallel, etc.). For example, the machine learning model may include a second model in series with the first model, and cause the computing system to generate a second plurality of output values based on the combined value, the second plurality of output values including values from the second model and each adapter of the second model. In another example, the machine learning model may include a second model in parallel with the first model, and cause the computing system to generate a second plurality of output values based on the input tokens associated with the input content, the second plurality of output values including values from the second model and each adapter of the second model. In either case, the second model includes adapters that are separately trained in cluster epochs and are activated to implement specialized training.

At block 710, the computing system may output, by the machine learning model, content generated based on the combined value.

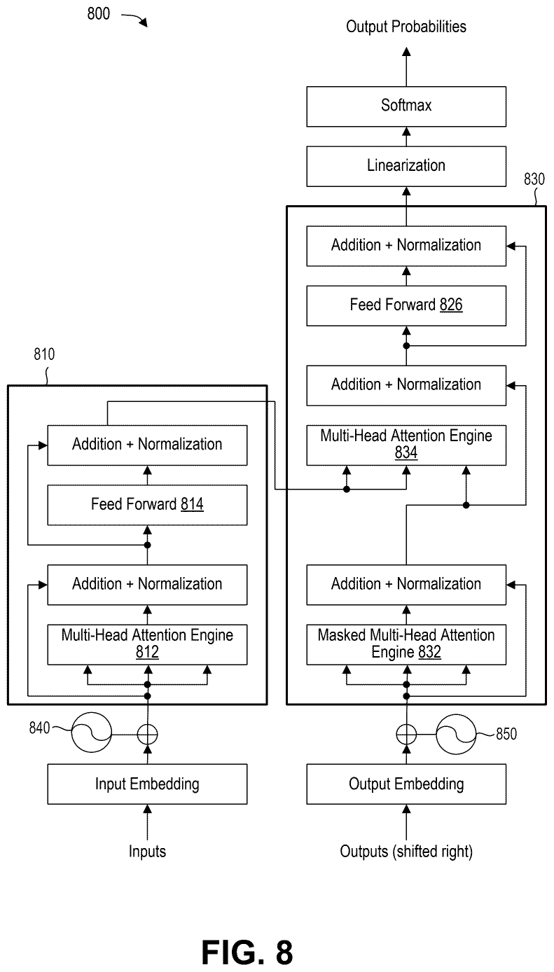

FIG. 8 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. The transformer 800 reduces the operations of learning dependencies by using an encoder 810 and a decoder 830 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 810 is composed of a stack of six identical layers and each layer has two sub-layers. The first sub-layer is a multi-head self-attention engine 812, and the second sub-layer is a fully connected feed-forward network 814. A residual connection (not shown) connects around each of the sub-layers followed by normalization.

In this example of a transformer 800, the decoder 830 is also composed of a stack of six identical layers. The decoder also includes a masked multi-head self-attention engine 832, a multi-head attention engine 834 over the output of encoder 810, and a fully connected feed-forward network 826. Each layer includes a residual connection (not shown) around the layer, which is followed by layer normalization. The masked multi-head self-attention engine 832 is masked to prevent positions from attending to subsequent positions and ensures that the predictions at position i can depend only on the known outputs at positions less than i (e.g., auto-regression).

In the transformer 800, the queries, keys, and values are linearly projected by a multi-head attention engine into learned linear projects, and then attention is performed in parallel on each of the learned linear projects, which are concatenated and then projected into final values.

The transformer also includes a positional encoder 840 to encode positions because the model does not contain recurrence and convolution and relative or absolute position of the tokens is needed. For example, the positional encodings are added to the input embeddings at the bottom layer of the encoder 810 and the decoder 830. The positional encodings are summed with the embeddings because the positional encodings and embeddings have the same dimensions. A corresponding position decoder 850 is configured to decode the positions of the embeddings for the decoder 830.

In some aspects, the transformer 800 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 800 can process input sequences of variable length, making it well-suited for natural language processing tasks where input lengths can vary greatly. Additionally, the self-attention mechanism allows the transformer 800 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 9 is a diagram illustrating an example of a system for implementing certain aspects of the present technology. In particular, FIG. 9 illustrates an example of a computing system 900, which can be for example any computing device making up internal computing system, a remote computing system, a camera, or any component thereof in which the components of the system are in communication with each other using a connection 905. The connection 905 can be a physical connection using a bus, or a direct connection into the processor 910, such as in a chipset architecture. The connection 905 can also be a virtual connection, networked connection, or logical connection.

In some aspects, the computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

An example computing system 900 includes at least one processing unit (a central processing unit (CPU) or processor) 910 and a connection 905 that couples various system components including a system memory 915, such as ROM 920 and RAM 925 to te processor 910. The computing system 900 can include a cache 912 of high-speed memory connected directly with, in close proximity to, or integrated as part of the processor 910.

The processor 910 can include any general purpose processor and a hardware service or software service, such as services 932, 934, and 936 stored in the storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction, the computing system 900 includes an input device 945, which can represent any number of input mechanisms, such as a microphone for speech, a touch-sensitive screen for gesture or graphical input, keyboard, mouse, motion input, speech, etc. The computing system 900 can also include an output device 935, which can be one or more of a number of output mechanisms. In some instances, multimodal systems can enable a user to provide multiple types of input/output to communicate with the computing system 900. The computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as the processor 910, the connection 905, the output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 600, process 700, and/or other process described herein) may be performed by a computing device or apparatus. In one example, the process 600, process 700 can be performed by a computing device having a computing architecture of the computing system 900 shown in FIG. 9.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”)symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for generating content, comprising: at least one memory; and at least one processor coupled to the at least one memory and configured to: obtain a plurality of embeddings associated with input content; determine, for the plurality of embeddings, a plurality of probability values corresponding to a plurality of clusters, wherein each probability value corresponds to a probability a respective embedding belongs to a particular cluster of the plurality of clusters; generate, using a first model of a machine learning model, a plurality of output values based on input tokens associated with the input content, the plurality of output values including a first output value associated with the first model, a second output value associated with a first adapter of the first model, and a third output value associated with a second adapter of the first model; combine the plurality of output values based on the plurality of probability values into a combined value; and output content generated based on the combined value.
Aspect 2. The apparatus of Aspect 1, wherein the at least one processor is configured to: scale the second output value based on a number of clusters in the plurality of clusters; scale the third output value based on the number of clusters in the plurality of clusters; and sum the first output value, the scaled second output value, and the scaled third output value to generate the combined value.
Aspect 3. The apparatus of any of Aspects 1 to 2, wherein the at least one processor is configured to: scale the second output value based on a first probability value from the plurality of probability values corresponding the first adapter; scale the third output value based on a second probability value from the plurality of probability values corresponding the second adapter; and sum the first output value, the scaled second output value, and the scaled third output value to generate the combined value.
Aspect 4. The apparatus of any of Aspects 1 to 3, wherein the at least one processor is configured to: determine a first distance from the plurality of embeddings to a first centroid associated with a first cluster corresponding to the first adapter; determine a second distance from the plurality of embeddings to a second centroid associated with a second cluster corresponding to the second adapter; and determine a first probability and a second probability based on the first distance and the second distance.
Aspect 5. The apparatus of Aspect 4, wherein the at least one processor is configured to: normalize the first distance and the second distance based on a normal value; and compute the probability based on the normalized first distance and the normalized second distance.
Aspect 6. The apparatus of any of Aspects 4 to 5, wherein the first adapter is trained based on modifying training data associated with the second cluster to learn away from the second cluster.
Aspect 7. The apparatus of any of Aspects 1 to 6, wherein the at least one processor is configured to: generate, by a second model of the machine learning model, a second plurality of output values based on the combined value, the second plurality of output values including values from the second model and each adapter of the second model.
Aspect 8. The apparatus of any of Aspects 1 to 7, wherein the at least one processor is configured to: generate, by a second model of the machine learning model, a second plurality of output values based on the input tokens associated with the input content, the second plurality of output values including values from the second model and each adapter of the second model.
Aspect 9. The apparatus of any of Aspects 1 to 8, wherein the at least one processor is configured to: generate first tokens associated with a first portion of the content based on a type of the first portion using a first encoder; generate second tokens associated with a second portion of the content based on a type of the second portion using a second encoder; and combine the first tokens and the second tokens into the input tokens.
Aspect 10. The apparatus of any of Aspects 1 to 9, wherein a number of the plurality of clusters is equal to a number of adapters.
Aspect 11. A method of generating content, comprising: obtaining a plurality of embeddings associated with input content; determining, for the plurality of embeddings, a plurality of probability values corresponding to a plurality of clusters, wherein each probability value corresponds to a probability a respective embedding belongs to a particular cluster of the plurality of clusters; generating, by a first model of a machine learning model, a plurality of output values based on input tokens associated with the input content, the plurality of output values including a first output value associated with the first model, a second output value associated with a first adapter of the first model, and a third output value associated with a second adapter of the first model; combining the plurality of output values based on the plurality of probability values into a combined value; and outputting, by the machine learning model, content generated based on the combined value.
Aspect 12. The method of Aspect 11, wherein combining the plurality of output values based on the plurality of probability values into the combined value comprises: scaling the second output value based on a number of clusters in the plurality of clusters; scaling the third output value based on the number of clusters in the plurality of clusters; and summing the first output value, the scaled second output value, and the scaled third output value to generate the combined value.
Aspect 13. The method of any of Aspects 11 to 12, wherein combining the plurality of output values based on the plurality of probability values into the combined value comprises: scaling the second output value based on a first probability value from the plurality of probability values corresponding the first adapter; scaling the third output value based on a second probability value from the plurality of probability values corresponding the second adapter; and summing the first output value, the scaled second output value, and the scaled third output value to generate the combined value.
Aspect 14. The method of any of Aspects 11 to 13, wherein determining the plurality of probability values comprises: determining a first distance from the plurality of embeddings to a first centroid associated with a first cluster corresponding to the first adapter; determining a second distance from the plurality of embeddings to a second centroid associated with a second cluster corresponding to the second adapter; and determining a first probability and a second probability based on the first distance and the second distance.
Aspect 15. The method of Aspect 14, wherein determining the first probability and the second probability comprises: normalizing the first distance and the second distance based on a normal value; and computing the probability based on the normalized first distance and the normalized second distance.
Aspect 16. The method of any of Aspects 14 to 15, wherein the first adapter is trained based on modifying training data associated with the second cluster to learn away from the second cluster.
Aspect 17. The method of any of Aspects 11 to 16, further comprising: generating, by a second model of the machine learning model, a second plurality of output values based on the combined value, the second plurality of output values including values from the second model and each adapter of the second model.
Aspect 18. The method of any of Aspects 11 to 17, further comprising: generating, by a second model of the machine learning model, a second plurality of output values based on the input tokens associated with the input content, the second plurality of output values including values from the second model and each adapter of the second model.
Aspect 19. The method of any of Aspects 11 to 18, further comprising: generating first tokens associated with a first portion of the content based on a type of the first portion using a first encoder; generating second tokens associated with a second portion of the content based on a type of the second portion using a second encoder; and combining the first tokens and the second tokens into the input tokens.
Aspect 20. The method of any of Aspects 11 to 19, wherein a number of the plurality of clusters is equal to a number of adapters.
Aspect 21. A non-transitory computer-readable medium having stored thereon instructions that, when executed by at least one processor, cause the at least one processor to perform operations according to any of Aspects 11 to 20.
Aspect 22. An apparatus for generating content, comprising one or more means for performing operations according to any of Aspects 11 to 20.
Aspect 23. A method of training a machine learning model, comprising: obtaining a plurality of clusters associated with a dataset, the plurality of clusters including at least a first cluster and a second cluster; tuning a first adapter connected to a first machine learning model based on the dataset and the plurality of clusters; tuning a second adapter connected to the first machine learning model based on the dataset and the plurality of clusters; and obtaining a second machine learning model based on combining the first adapter and the second adapter with the first machine learning model.

What is claimed is:

1. An apparatus for generating content, comprising:
at least one memory; and
at least one processor coupled to the at least one memory and configured to:
obtain a plurality of embeddings associated with input content;
determine, for the plurality of embeddings, a plurality of probability values corresponding to a plurality of clusters, wherein each probability value corresponds to a probability a respective embedding belongs to a particular cluster of the plurality of clusters;
generate, using a first model of a machine learning model, a plurality of output values based on input tokens associated with the input content, the plurality of output values including a first output value associated with the first model, a second output value associated with a first adapter of the first model, and a third output value associated with a second adapter of the first model;
combine the plurality of output values based on the plurality of probability values into a combined value; and
output content generated based on the combined value.

2. The apparatus of claim 1, wherein the at least one processor is configured to:
scale the second output value based on a number of clusters in the plurality of clusters;
scale the third output value based on the number of clusters in the plurality of clusters; and
sum the first output value, the scaled second output value, and the scaled third output value to generate the combined value.

3. The apparatus of claim 1, wherein the at least one processor is configured to:
scale the second output value based on a first probability value from the plurality of probability values corresponding the first adapter;
scale the third output value based on a second probability value from the plurality of probability values corresponding the second adapter; and
sum the first output value, the scaled second output value, and the scaled third output value to generate the combined value.

4. The apparatus of claim 1, wherein the at least one processor is configured to:
determine a first distance from the plurality of embeddings to a first centroid associated with a first cluster corresponding to the first adapter;
determine a second distance from the plurality of embeddings to a second centroid associated with a second cluster corresponding to the second adapter; and
determine a first probability and a second probability based on the first distance and the second distance.

5. The apparatus of claim 4, wherein the at least one processor is configured to:
normalize the first distance and the second distance based on a normal value; and
compute the probability based on the normalized first distance and the normalized second distance.

6. The apparatus of claim 4, wherein the first adapter is trained based on modifying training data associated with the second cluster to learn away from the second cluster.

7. The apparatus of claim 1, wherein the at least one processor is configured to:
generate, by a second model of the machine learning model, a second plurality of output values based on the combined value, the second plurality of output values including values from the second model and each adapter of the second model.

8. The apparatus of claim 1, wherein the at least one processor is configured to:
generate, by a second model of the machine learning model, a second plurality of output values based on the input tokens associated with the input content, the second plurality of output values including values from the second model and each adapter of the second model.

9. The apparatus of claim 1, wherein the at least one processor is configured to:
generate first tokens associated with a first portion of the content based on a type of the first portion using a first encoder;
generate second tokens associated with a second portion of the content based on a type of the second portion using a second encoder; and
combine the first tokens and the second tokens into the input tokens.

10. The apparatus of claim 1, wherein a number of the plurality of clusters is equal to a number of adapters.

11. A method of generating content, comprising:
obtaining a plurality of embeddings associated with input content;
determining, for the plurality of embeddings, a plurality of probability values corresponding to a plurality of clusters, wherein each probability value corresponds to a probability a respective embedding belongs to a particular cluster of the plurality of clusters;
generating, by a first model of a machine learning model, a plurality of output values based on input tokens associated with the input content, the plurality of output values including a first output value associated with the first model, a second output value associated with a first adapter of the first model, and a third output value associated with a second adapter of the first model;
combining the plurality of output values based on the plurality of probability values into a combined value; and
outputting, by the machine learning model, content generated based on the combined value.

12. The method of claim 11, wherein combining the plurality of output values based on the plurality of probability values into the combined value comprises:
scaling the second output value based on a number of clusters in the plurality of clusters;
scaling the third output value based on the number of clusters in the plurality of clusters; and
summing the first output value, the scaled second output value, and the scaled third output value to generate the combined value.

13. The method of claim 11, wherein combining the plurality of output values based on the plurality of probability values into the combined value comprises:
scaling the second output value based on a first probability value from the plurality of probability values corresponding the first adapter;
scaling the third output value based on a second probability value from the plurality of probability values corresponding the second adapter; and
summing the first output value, the scaled second output value, and the scaled third output value to generate the combined value.

14. The method of claim 11, wherein determining the plurality of probability values comprises:
determining a first distance from the plurality of embeddings to a first centroid associated with a first cluster corresponding to the first adapter;
determining a second distance from the plurality of embeddings to a second centroid associated with a second cluster corresponding to the second adapter; and
determining a first probability and a second probability based on the first distance and the second distance.

15. The method of claim 14, wherein determining the first probability and the second probability comprises:
normalizing the first distance and the second distance based on a normal value; and
computing the probability based on the normalized first distance and the normalized second distance.

16. The method of claim 14, wherein the first adapter is trained based on modifying training data associated with the second cluster to learn away from the second cluster.

17. The method of claim 11, further comprising:
generating, by a second model of the machine learning model, a second plurality of output values based on the combined value, the second plurality of output values including values from the second model and each adapter of the second model.

18. The method of claim 11, further comprising:
generating, by a second model of the machine learning model, a second plurality of output values based on the input tokens associated with the input content, the second plurality of output values including values from the second model and each adapter of the second model.

19. The method of claim 11, further comprising:
generating first tokens associated with a first portion of the content based on a type of the first portion using a first encoder;
generating second tokens associated with a second portion of the content based on a type of the second portion using a second encoder; and
combining the first tokens and the second tokens into the input tokens.

20. The method of claim 11, wherein a number of the plurality of clusters is equal to a number of adapters.
